(19) United States
(12) Patent Application Publication
(10) Pub. No.: US 2010/0044479 A1
(43) Pub. Date: Feb. 25, 2010

(54) Cooling and comminution of particulate material

(75) Inventor: Jason S. Euculano, Northampton, PA (US)

Correspondence Address: Daniel DeJoseph;FlSmidth Inc., 2040 Avenue "C", Bethlehem, PA, 18017, US

(73) Assignee: FLSmidth A/S

(21) Appl. No.: 12/229,242

(22) Filed: Aug. 21, 2008

(51) Int. Cl. B02C 23/08; B02C 4/00; B02C 25/00

(52) U.S. Cl. 241/23; 241/24.1; 241/65; 241/68; 241/81; 241/220

(57) ABSTRACT

Disclosed is a method of cooling hot material having different particle sizes that has been heat treated in a kiln. The material is first passed through a cooling apparatus, after which it is delivered to a screening apparatus for screening out smaller material below a pre-determined fineness and transporting larger material above such pre-determined fineness to a crushing apparatus. The larger material is crushed and is delivering back to the cooling apparatus for further cooling. It is a feature of the invention that the cooling apparatus, screening apparatus and crushing apparatus have a common environment, that is, they are all enclosed within the same housing.

The invention relates to a method of cooling and comminuting particulate material and an apparatus for practicing the method. This invention relates to a method of and apparatus for breaking and cooling the coarse portion of a hot material having a substantial range of particle size. The invention can be used in any minerals application in which rocks are first burned and then cooled, such as for example, in treating the clinker of mixed size frequently produced during the manufacture of Portland cement.

The present method of cooling and comminuting particulate material is utilized in conjunction with cooling material which has been burnt in a kiln or heated by some other process. The cooling apparatus used in the present method can comprise stationary or movable grate coolers and other coolers. The method of operation of the above and other coolers is well known in the art.

### BACKGROUND OF THE INVENTION

Typically kilns in a cement making operation produce clinker product having different sizes. When cooling such material, large clinker particles do not cool as efficiently as smaller particles due to the ratio of particle surface area to particle volume. When such large particles are discharged from a clinker cooler they may still contain large quantities of heat, necessitating additional and frequently costly processing steps in subsequent cement plant operations.

It is known to use roll breakers downstream from such clinker cooler installations. The roll breaker's function is to reduce the size of large clinker agglomerations as they leave the clinker cooler. In some cases it is known to employ roll breakers at the front of the cooler, wherein all the cooler function is after the roll breaker, or in mid-cooler, that is, any location where there is cooler function both before and after the roll breaker, to break up the larger pieces of clinker in an attempt to avoid the problems specified above. From a clinker-cooler process standpoint the front cooler or mid-cooler roller breakers would appear to be desired solutions because either situation allows the cooler to operate on smaller clinker, which is easier to properly cool. However, a front or mid cooler roller breaker is not a good option economically because of a high operating temperature (exceeding approximately 550° C.) and thus the roller breaker faces a multitude of complications required for high-temperature service (refractory, shaft and frame cooling systems, etc).

It would be advantageous, therefore, and it is an object of the present invention to have a clinker processing system that utilizes a clinker cooler in conjunction with a roll breaker in which there is achieved the advantages of utilizing a front or mid-cooler breaker in that the cooler will thereby treat smaller sized particles to thereby raise the efficiencies of the cooler without the inherent disadvantages of a front or mid-cooler breaker that involve operating a roll breaker in an extreme temperature environment.

### SUMMARY OF THE INVENTION

The above and other objects are achieved by using a crushing means located at the discharge end of and in the same environment as the clinker cooler, in conjunction with a screening means located intermediate the discharge end of the cooler and the crushing means to first remove fully cooled smaller sized clinker for transportation to the next step in the process. The larger size material that are not removed are comminuted in the crushing means and then transported via a mechanical transportation system (for example, a pan conveyor used in conjunction with a screw feeder) and re-introduced in the mid-cooler area. Most preferably the screening means and the crushing means are embodied in the same device, a roll breaker.

### DESCRIPTION OF THE DRAWINGS

FIG. 1 is a sectional, side view of one embodiment of the invention in which the roll breaker utilized in the method of the invention is a four roll breaker having transport/screening shafts and crushing shafts.

FIG. 2 is a sectional, side view of another embodiment of the invention in which a two roll breaker is utilized as a crushing means in conjunction with a separate dynamic screening device.

FIG. 3 is a sectional, side view of another embodiment of the invention in which a two roll breaker is utilized as a crushing means in conjunction with a separate static screening device.

### DETAILED DESCRIPTION OF THE INVENTION

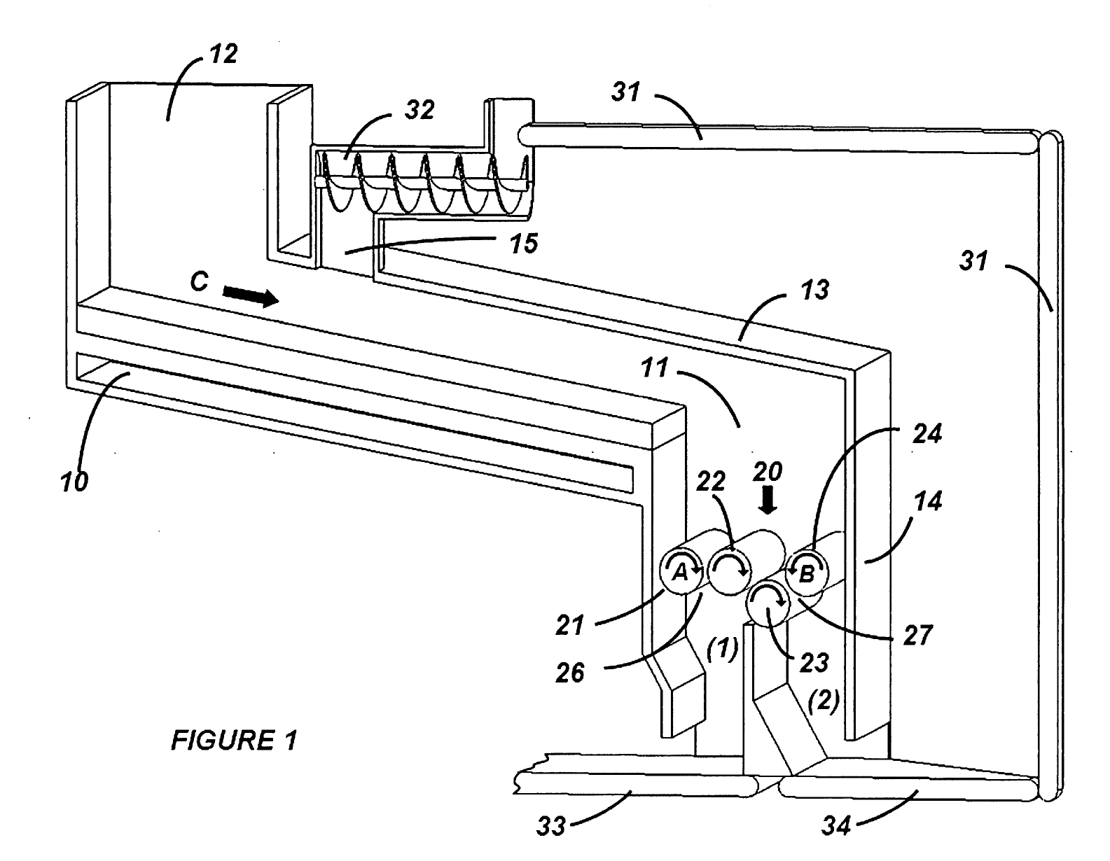

Referring to FIG. 1, there is depicted one embodiment of the system and method of the present invention in which there is a clinker cooler 10 having a clinker discharge end 11 remote from clinker inlet end 12. It should also be noted that cooler 10 can be of any design and no particular specific type of clinker cooler is especially preferred for use in the present invention. Roll breaker 20 is positioned immediately after clinker discharge end 11.

Clinker material is transported through the cooler from inlet 12 to outlet 11 in the direction of Arrow C. It is a feature of the present invention that roll breaker 20 is located within the same enclosed environment as cooler 10, in that they both share a common housing which is, for example, comprised in part of enclosing roof 13 and end wall 14. No external transportation devices are required to transport material from the cooler to the roll breaker, and most preferably material will fall by gravity from clinker discharge end 11 to roll breaker 20.

A roll breaker suitable for use in the invention will contain at least two rolls in series, and generally between two to six rolls, and the top of each of the rolls may or may not be on the same horizontal plane. Roll breaker 20 consists of, in the depicted embodiment, four rolls in series designated by the numbers 21, 22, 23 and 24. Rolls 21 and 22 comprise screening and transport section 1. As such rolls 21 and 22 serve to screen out the smaller particles (which will pass through the gap 26 between rolls 21 and 22) and also to transport material to crushing rolls 23 and 24. The material falling between rolls 21 and 22 will be transported to the next step in the process, such as via conveyor 33.

In typical clinker cooling operations, the screening rolls will be placed relative to each other and the crusher rolls to screen out particles having a maximum size of about 20 mm, although this invention is not to limited to any specific size for the screened particles, and it is further understood that the size of both the particle being filtered and the preferred size to which the larger material is comminuted are industry dependant, as mineral operations other than cement may have different size requirements. In any event, particles larger than a specified size will be directed to crusher rolls 23 and 24 between which the particles will be comminuted to a desired size of less than about 20 mm in cement operations.

In one embodiment of the invention as set forth in FIG. 1, the rolls are not located on a straight horizontal line, but the uppermost point, i.e., the top, of the transport rolls 21 and 22 is located at a higher level than the top of the first crushing roll 23 that is immediately adjacent to the transport rolls so that material will naturally move to the first crushing roll by action of gravity, and, furthermore, the top of the last crushing roll 24, i.e., the roll furthest removed from the transport rolls, is located higher than the top of the crushing roll 23 to aid in preventing material from moving over crushing roll 24 and therefore not being crushed.

As depicted in FIG. 1, the rotation of the transport rolls 21 and 22 and first crushing roll 23 are as specified by arrow A, which, in the perspective of FIG. 1, are rotating in a clockwise direction. Crushing roll 24 rotates in the direction specified by arrow B, which is the opposite direction from first crushing roll 23 to thereby draw the material into gap 27 located between the crushing rolls 23 and 24, whereupon the material will be broken down.

After the crushing step the still hot clinker is transported to a secondary material inlet 15 located between the cooler clinker inlet 12 and outlet 11 for further cooling. As depicted the clinker is transported by conveyor 34 to a transport device, which can be, for example, a mechanical transport device such as pan-conveyor 31, that feeds the material into a screw conveyor 32 which inserts the material to a cooler via inlet 15. Other forms of transport mechanisms suitable for use in the invention include other mechanical conveyors such as a drag chain conveyor or a non-mechanical conveyance means such as a hot fluidized bed conveying device. Preferably an air-lock feeder mechanism, such as screw conveyor 32, is used to insert the material into to cooler. Other feeder devices such as a rotary feeder or a flap valve can also be employed.

As indicated, material moves through cooler 10 in the direction of arrow C. In zone (1) material beneath a certain desired fineness is screened out of the cooled material and is sent to the next stage of the process, in the case of a cement process, finish grinding. This is material that is small enough to be effectively cooled by the cooler. Material above the desired fineness is transported to zone 2, in which such material is subject to crushing. This crushed material is still too hot for downstream operations and therefore is recycled back to the cooler.

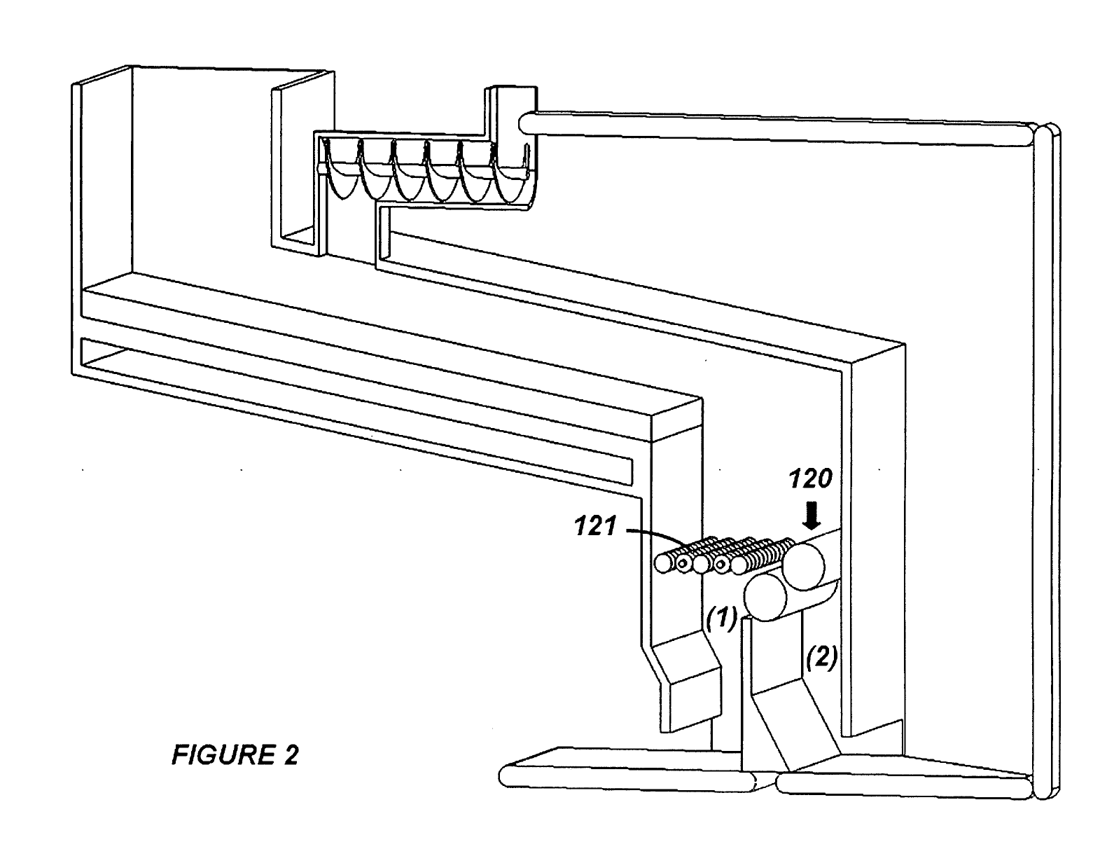

FIG. 2 shows the use of a two roll breaker 120 in conjunction with a separate screening device 121 which takes the place of the initial transport and screening rolls 21 and 22 in a four roll breaker. The screening device is a “dynamic” screening device having at least one movable part. The specific device shown utilizes rotating discs, although other dynamic screening designs such as a reciprocating bar screener are contemplated for use in the invention.

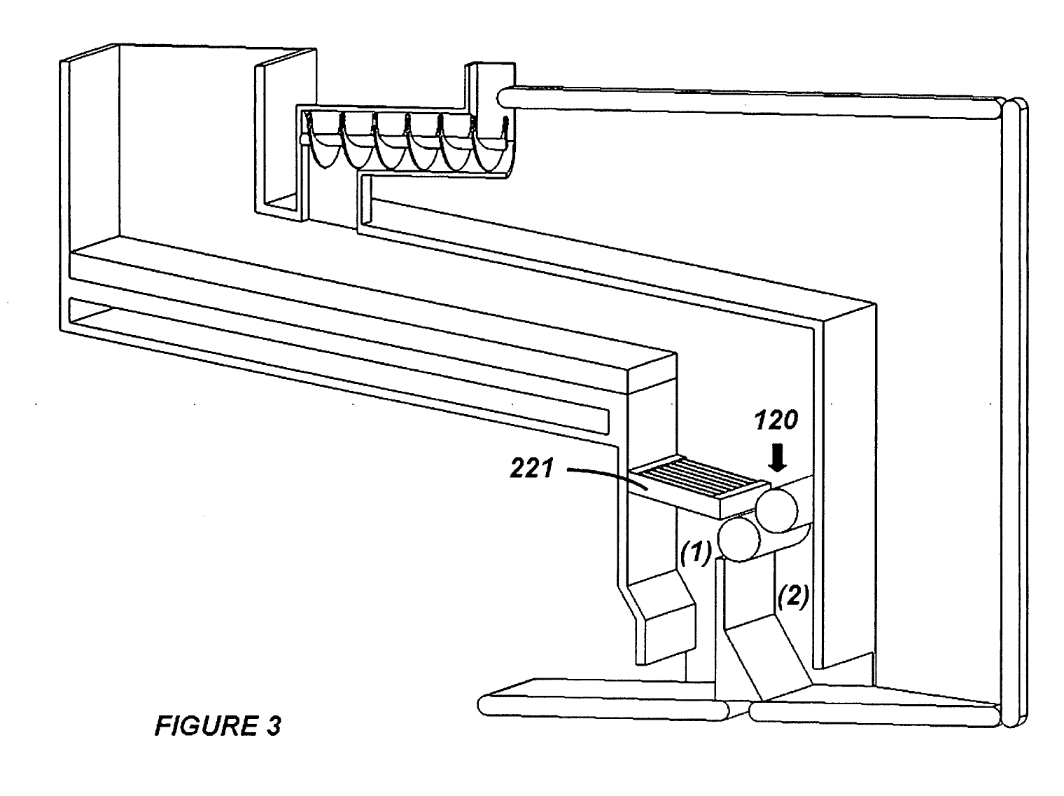

FIG. 3 shows the use of a two roll breaker 120 in conjunction with an alternative separate screening device 221 which also takes the place of the initial transport and screening rolls 21 and 22 in a four roll breaker. The screening device depicted is a “static” screening device having only stationary parts. The device shown is a bar gizzly which is deployed at an angle so that material will move over it by gravity. Other static designs such as a screening grate are contemplated for use in the invention. It is also considered to be understood that other embodiments and modifications of the described embodiments are possible within the scope of the invention which is limited only by the attached claims.

What is claimed is:

1. In a material processing process, a method of cooling hot material having different particle sizes that has been heat treated in a kiln comprising
(i) delivering the material to and passing the material through a cooling apparatus that is enclosed within a housing and has a first material inlet and a material outlet;
(ii) delivering the cooled material from the material outlet to a screening apparatus located within the housing, in which screening apparatus material below a pre-determined fineness is screened out and transported to a next step of the process and material above such pre-determined fineness is transported to a crushing apparatus that immediately follows and is also located within the housing;
(iii) crushing the material in the crushing apparatus to a desired fineness;
(iv) delivering the crushed material back to the cooling apparatus for further cooling.

2. The method of claim 1 wherein the hot material is cement clinker.

3. The method of claim 1 wherein the screening apparatus immediately follows the cooling apparatus.

4. The method of claim 1 wherein the crushed material is delivered to a second material inlet located intermediate the first material inlet and the material outlet.

5. The method of claim 1 wherein the screening apparatus and the cooling apparatus are embodied in a roll breaker that has a first and second set of rolls, wherein the first set of rolls serve to both screen the material to remove material below such certain pre-determined fineness and to transport material above such pre-determined fineness to the second set of rolls that serve to crush the material.

6. The method of claim 1 wherein the screening apparatus is a dynamic screening device.

7. The method of claim 1 wherein the screening apparatus is a static screening device.

8. The method of claim 1 wherein the crushed material is delivered to the cooling apparatus via a mechanical transport device.

9. The method of claim 1 wherein the crushed material is delivered to the cooling apparatus via a hot fluidized bed conveying device.

10. The method of claim 1 wherein an air-lock feeder is used to insert the material into the cooler.

11. An apparatus for treating hot material having different particle sizes that has been heat treated in a kiln comprising
(i) a cooling apparatus for cooling the particulate material having a first material inlet and a material outlet, said cooling apparatus being located within a housing;
(ii) a screening apparatus for the material, said screening apparatus (a) being located within the housing and immediately adjacent to the material outlet and (b) being adapted to screen out small cooled material below a pre-determined fineness and to transport large cooled material above such pre-determined fineness to a crushing apparatus;
(iii) a crushing apparatus located within the housing and immediately adjacent to the screening apparatus, for crushing said large material; and
(iv) means for delivering said crushed material back to the cooler for further cooling.

12. The apparatus of claim 11 wherein the cooling apparatus is a cement clinker cooler.

13. The apparatus of claim 11 wherein the cooling apparatus has a second material inlet for crushed material located intermediate the first material inlet and the material outlet.

14. The apparatus of claim 11 wherein the screening apparatus and the cooling apparatus are embodied in a roll breaker that has a first and second set of rolls, wherein the first set of rolls serve to both screen out the small material and to transport said to the second set of rolls that serve to crush the material.

15. The apparatus of claim 11 wherein the screening apparatus is a dynamic screening device.

16. The apparatus of claim 11 wherein the screening apparatus is a static screening device.

17. The apparatus of claim 11 wherein the means for delivering said crushed material back to the cooler for further cooling comprises a combination of a mechanical transport device and an air-lock feeder.

18. The apparatus of claim 17 wherein the air-lock feeder is a screw conveyor

19. The method of claim 1 wherein the means for delivering said crushed material back to the cooler for further cooling comprises a combination of a hot fluidized bed conveying device and an air-lock feeder.

20. An apparatus for treating cement clinker having different particle sizes that has been heat treated in a kiln comprising
(i) a clinker cooler apparatus for cooling the cement clinker having a first material inlet and a material outlet, said clinker cooler s being located within a housing;
(ii) a roll breaker being located within the housing and immediately adjacent to the material outlet having a first and second set of rolls, wherein the first set of rolls serve to both screen out small cooled material below a pre-determined fineness and to transport large cooled material above such pre-determined fineness to the second set of rolls that serve to crush the large material; and
(iii) means for delivering said crushed clinker back to the cooler at a second material inlet located intermediate the first material inlet and the material outlet for further cooling.
